(19) United States
(12) Patent Application Publication
(10) Pub. No.: US 2022/0344140 A1
(43) Pub. Date: Oct. 27, 2022

(54) ION ANALYZER

(71) Applicant: SHIMADZU CORPORATION, Kyoto-shi, Kyoto (JP)

(72) Inventors: Hidenori TAKAHASHI, Kyoto-shi, Kyoto (JP); Koichi TANAKA, Kyoto-shi, Kyoto (JP)

(73) Assignee: SHIMADZU CORPORATION, Kyoto-shi, Kyoto (JP)

(21) Appl. No.: 17/761,063

(22) PCT Filed: Apr. 13, 2020
(86) PCT No.: PCT/JP2020/016269

§ 371 Date: Mar. 16, 2022

(30) Foreign Application Priority Data
Sep. 18, 2019 (JP) 2019-169230
Mar. 31, 2020 (JP) 2020-064842

(51) Int. Cl. H01J 49/04; H01J 49/14

(52) U.S. Cl. CPC H01J 49/0422; H01J 49/0495; H01J 49/14; H01J 49/005

(57) ABSTRACT

An ion analyzer includes: a reaction chamber 2 into which precursor ions derived from a sample component are introduced; a radical generation unit including an insulating tube 551, and a discharge unit 54, 552 configured to generate a discharge inside the insulating tube; a gas supply unit 52, 53 capable of supplying a first gas which is a radical raw material gas, and a second gas which is any of an oxygen gas, an ozone gas, a nitrogen gas, a gas of a compound containing an oxygen atom or a nitrogen atom, and a rare gas to an inside of the insulating tube; an evacuation unit 57 configured to evacuate the inside of the insulating tube; a radical introduction unit 55 configured to introduce radicals into an inside of the reaction chamber; and a control unit 93 configured to perform a first operation of introducing the first gas into the inside of the insulating tube, generating radicals by generating a discharge, and introducing the radicals into the inside of the reaction chamber, and a second operation of introducing the second gas into the inside of the insulating tube.

### TECHNICAL FIELD

The present invention relates to an ion analyzer which detects product ions generated by dissociating precursor ions by irradiating the precursor ions derived from a sample component with radicals.

### BACKGROUND ART

In order to identify a polymer compound or analyze its structure, mass spectrometry is widely used in which precursor ions derived from a sample component are dissociated one or more times to generate fragment ions (which is also called product ions), and the fragment ions are separated and detected according to a mass-to-charge ratio. As an apparatus for performing such a mass spectrometry, for example, an ion trap-time-of-flight mass spectrometer or a triple quadrupole mass spectrometer is used.

As a method for dissociating precursor ions, a Collision Induced Dissociation (CID) method is most commonly used in which precursor ions are collided with an inert gas such as an argon gas to induce dissociation. In the ion trap-time-of-flight mass spectrometer, ions generated from a sample component are trapped in an ion trap, ions having a predetermined mass-to-charge ratio are selected from the ions as precursor ions, and then the selected ions are vibrated to collide with an inert gas. In the triple quadrupole mass spectrometer, ions having a predetermined mass-to-charge ratio are selected as precursor ions by the front-stage quadrupole mass filter from ions generated from a sample component. Then, the precursor ions having passed through the front-stage quadrupole mass filter are accelerated and introduced into the second stage quadrupole mass filter, which functions as a collision cell, and collide with the inert gas of the collision cell.

However, in the CID method, since the energy imparted to the precursor ions by collision is dispersed among the entire ions, the selectivity of the position where the precursor ions are dissociated is low. Accordingly, the ion dissociation method is not suitable when it is necessary to dissociate precursor ions at a specific site (e.g., binding position of amino acid) when, for example, a protein or a peptide is analyzed.

The present inventor has proposed, in Patent Literature 1, a Hydrogen Attachment/Abstraction Dissociation (HAD) method, in which unpaired electron-induced dissociation is generated by irradiating peptide-derived precursor ions with hydrogen radicals. In Patent Literature 1, an insulating tube with a coil wound around the outer periphery is first evacuated, and then hydrogen gas is introduced. Radio-frequency power is supplied to the coil to generate vacuum discharge inside the insulating tube to generate hydrogen radicals, and the hydrogen radicals are used to irradiate precursor ions trapped in an ion trap.

In Patent Literature 1, the present inventor has also proposed that precursor ions derived from peptides are specifically dissociated at a binding position of an amino acid using hydroxy radicals, oxygen radicals, or nitrogen radicals. When the precursor ions derived from peptides are irradiated with these radicals, product ions of a/x series and product ions of c/z series are generated.

### CITATION LIST

### Patent Literature

Patent Literature 1: WO 2018/186286 A

Patent Literature 2: US 2010/0171035 A

### Non Patent Literature

Non Patent Literature 1: Tatsuya Imoto, et al., “Thermal decomposition of nickel oxide”, Journal of Japanese Chemistry, Vol. 86, No. 7, pp. 694-696 (1965)

Non Patent Literature 2: Yoshio Harano, “Release of atomic oxygen in thermal decomposition of metal oxide”, Journal of Japanese Chemistry, Vol. 82, No. 2, pp. 152-155 (1961)

### SUMMARY OF INVENTION

### Technical Problem

In the mass spectrometer described in Patent Literature 1, the detection sensitivity and the mass accuracy of product ions deteriorate as the analyses of sample components using the HAD method or the like are repeated.

An object of the present invention is to avoid deterioration in detection sensitivity and mass accuracy of product ions in an ion analyzer which detects product ions generated by dissociating precursor ions derived from a sample component by irradiating the precursor ions with radicals.

### Solution to Problem

A first aspect of the present invention made to solve the above problems is an ion analyzer configured to generate product ions from precursor ions derived from a sample component, and analyze the product ions, the ion analyzer including:

a reaction chamber into which the precursor ions are introduced;

a radical generation unit including an insulating tube, and a discharge unit configured to generate a discharge inside the insulating tube;

a gas supply unit configured to selectively supply a first gas which is a gas serving as a raw material of radicals, and a second gas which is any of an oxygen gas, an ozone gas, a nitrogen gas, a gas of a compound containing an oxygen atom or a nitrogen atom, and a rare gas to an inside of the insulating tube;

an evacuation unit configured to evacuate the inside of the insulating tube;

a radical introduction unit configured to introduce radicals generated inside the insulating tube into an inside of the reaction chamber; and

a control unit configured to control operations of the radical generation unit, the gas supply unit, the evacuation unit, and the radical introduction unit, the control unit being configured to perform a first operation of introducing the first gas into the inside of the insulating tube in a state where the inside of the insulating tube is evacuated, generating radicals by generating a discharge, and introducing the radicals into the inside of the reaction chamber, and a second operation of introducing the second gas into the inside of the insulating tube.

A second aspect of the present invention made to solve the above problems is an ion analyzer configured to generate product ions from precursor ions derived from a sample component, and analyze the product ions, the ion analyzer including:

a reaction chamber into which the precursor ions are introduced;

a gas supply unit configured to supply a first gas which is a gas having oxidizing ability and a second gas which is a gas having reducing ability;

a radical generation unit configured to generate radicals from the first gas;

a radical introduction unit configured to introduce the radicals generated in the radical generation unit into an inside of the reaction chamber; and

a control unit configured to control operations of the gas supply unit, the radical generation unit, and the radical introduction unit, the control unit being configured to perform a first operation of introducing the radicals generated from the first gas by the radical generation unit into the inside of the reaction chamber and a second operation of introducing the second gas into the inside of the reaction chamber.

A third aspect of the ion analyzer according to the present invention made to solve the above problems is an ion analyzer configured to generate product ions from precursor ions derived from a sample component, and analyze the product ions, the ion analyzer including:

a reaction chamber into which the precursor ions are introduced;

an oxidation reactant introduction unit configured to introduce a gas or a radical having oxidizing ability into an inside of the reaction chamber;

an electrode disposed in the reaction chamber and/or in a space communicating with the reaction chamber, the electrode having a surface formed of a metal whose oxide has a thermal decomposition temperature of 500° C. or lower; and

a heating unit configured to heat the electrode to the thermal decomposition temperature.

### Advantageous Effects of Invention

In the ion analyzer of the first aspect, under the control of the control unit, a first operation of introducing the first gas into the inside of the insulating tube in a state where the inside of the insulating tube is evacuated to generate a discharge to generate radicals and introduce the radicals into the inside of the reaction chamber, and a second operation of introducing the second gas into the inside of the insulating tube are executed. The first operation is a measurement operation performed to generate product ions by causing reaction between precursor ions derived from a sample component and radicals.

In the case of generating radicals by generating vacuum discharge inside an insulating tube whose inside is evacuated, an insulating tube made of a metal oxide or a metal nitride is generally used. The reason why the detection sensitivity of the product ions deteriorates while an operation is repeated to analyze the sample component in the conventional ion analyzer of is considered to be as follows. Due to the discharge generated inside the insulating tube, metal precipitates from the metal oxide or the metal nitride on an inner wall surface, and radicals adhere to the metal and disappear, so that the amount of radicals introduced into the reaction chamber decreases. In the ion analyzer of the first aspect, in addition to the first operation, the second operation of introducing the second gas into the inside of the insulating tube at the time of non-measurement is performed. At this time, when any of an oxygen gas, an ozone gas, a nitrogen gas, and a gas of a compound containing an oxygen atom or a nitrogen atom is used as the second gas, the metal deposited on the inner wall surface of the insulating tube reacts with the oxygen atom or the nitrogen atom contained in the second gas, and the metal, which eliminates the radicals, changes to a metal oxide or a metal nitride, so that it is possible to suppress a decrease in the amount of the radicals introduced into the reaction chamber at the time of measurement, and avoid deterioration in the detection sensitivity of the product ions. Further, when a rare gas is used as the second gas, atoms of the rare gas collide with the inner wall surface of the insulating tube, and the deposited metal is removed, whereby the same effect as described above can be obtained.

The first gas and the second gas in the ion analyzer of the first aspect may be the same gas, or may be different gases. For example, when precursor ions derived from a sample component are irradiated with oxygen radicals, oxygen gas can be used as the first gas and the second gas.

Further, when the second gas is introduced, it is preferable to irradiate the inner wall of the insulating tube with ultraviolet light. As a result, photoelectrons are emitted from the surface of the insulating tube, and the above effect can be enhanced. For example, if a quartz tube through which ultraviolet light is easily transmitted is selected as the insulating tube, the inside of the insulating tube can be irradiated with ultraviolet light by an ultraviolet lamp or the like installed outside the quartz tube. Since the work function of silicon dioxide constituting quartz is 4 eV or more and corresponds to 300 nm in wavelength, the wavelength of ultraviolet light is desirably 300 nm or less, preferably 280 nm or less, and further preferably 260 nm or less. Such an ultraviolet light source is easily available because it is sold as a germicidal lamp. Further, it is also possible to use a light emitting diode.

In the ion analyzer of the second aspect, under the control of the control unit, the first operation of generating radicals from the first gas and introducing the radicals into the inside of the reaction chamber, and the second operation of generating radicals from the second gas and introducing the radicals into the inside of the reaction chamber by the radical introduction unit are executed. The first operation is a measurement operation performed to generate product ions by reacting precursor ions derived from a sample component with radicals.

The reaction chamber is, for example, a collision cell or an ion trap. A collision cell or an ion trap used in an ion analyzer generally has a metal electrode, and a predetermined radio-frequency voltage or direct-current voltage is applied to the electrode to mass-separate, trap, or converge ions. The reason why the detection sensitivity and the mass accuracy of the product ions deteriorate while the operation of introducing radicals generated from a gas having an oxidizing ability into the reaction chamber is repeated in order to analyze the sample component in the conventional ion analyzer is considered to be that an insulating metal oxide adheres to an electrode surface in the reaction chamber, and the electric field formed inside the reaction chamber is disturbed. In the ion analyzer of the second aspect, the metal oxide formed on the electrode surface is reduced by the second gas by performing the second operation at the time of non-measurement, so that it is possible to avoid deterioration of the detection sensitivity and the mass accuracy of the product ions when the sample component is analyzed by the first operation.

The first gas and the second gas in the ion analyzer of the second aspect may be the same. When the same gas is used as the first gas and the second gas, the second operation is preferably performed under a condition (heating temperature, presence or absence of radicalization, and the like) in which the reducibility is stronger than the condition in performing the first operation. For example, carbon dioxide and water vapor can be used as the first gas and the second gas.

Also in the ion analyzer of the third aspect, similarly to the ion analyzer of the second aspect, product ions are generated from precursor ions derived from a sample component by a gas or a radical having oxidizing ability. Therefore, while the analysis of introducing a gas or a radical having oxidizing ability into the reaction chamber to generate precursor ions is repeatedly performed, surfaces of the electrode disposed in the reaction chamber and the electrode disposed in the space (for example, an ion transport optical system or a mass separation unit) communicating with the reaction chamber are oxidized. As a result, the electric field formed by the electrode is disturbed, and the detection sensitivity and the mass accuracy of ions are lowered.

In order to remove the oxide formed on the surface of the electrode, it is conceivable to heat the electrode. However, main components of stainless steel which has been conventionally used as an electrode material are iron, nickel, and chromium, and for example, a decomposition temperature of nickel oxide is as high as about 700° C. (see Non Patent Literature 1). In order to remove the oxide formed on the surface of the electrode made of stainless steel, it is necessary to heat the electrode to such a high temperature, but when such an electrode is heated to a temperature of higher than 500° C., expansion or distortion may occur, and disturbance may occur in the electric field which controls the behavior of ions. In the ion analyzer of the third aspect, since the electrode having the surface formed of the metal whose oxide has the thermal decomposition temperature of 500° C. or lower is used in the reaction chamber and/or the space communicating with the reaction chamber, it is possible to remove the oxide without causing expansion or distortion in the electrode and to avoid deterioration in detection sensitivity and mass accuracy of the product ions. Examples of the metal whose oxide has a thermal decomposition temperature of 500° C. or lower include gold, platinum, iridium, palladium, and silver (see Non Patent Literature 2 and the like).

### BRIEF DESCRIPTION OF DRAWINGS

FIG. 1 is a configuration diagram of a main part of a mass spectrometer of a first embodiment of an ion analyzer according to the present invention.

FIG. 2 is a configuration diagram of a main part of a radical generation/irradiation unit in the mass spectrometer of the first embodiment.

FIG. 3 is a mass spectrum obtained by irradiating fullerene ions with oxygen radicals using a new insulating tube in the mass spectrometer of the first embodiment.

FIG. 4 is a mass spectrum obtained by irradiating fullerene ions with oxygen radicals after repeated discharge in the mass spectrometer of the first embodiment.

FIG. 5 is a mass spectrum obtained by irradiating fullerene ions with oxygen radicals after performing recovery treatment by irradiation with oxygen radicals in the mass spectrometer of the first embodiment.

FIG. 6 is a configuration diagram of a main part of a mass spectrometer of a second embodiment of the ion analyzer according to the present invention.

FIG. 7 is a configuration diagram of a main part of a radical generation/irradiation unit in a mass spectrometer of the second embodiment.

FIG. 8 is a graph illustrating a result of obtaining a time taken for ions to pass through a collision cell when fullerene ions are irradiated with oxygen radicals using the mass spectrometer of the second embodiment.

FIG. 9 is a configuration diagram of a main part of a mass spectrometer of a third embodiment of the ion analyzer according to the present invention.

FIG. 10 is a configuration diagram of a main part of a radical generation/irradiation unit in the mass spectrometer of the third embodiment.

FIG. 11 is a graph illustrating a result of measuring a change in time during which ions pass through a collision cell by repeatedly performing radical irradiation and electrode heating using the mass spectrometer of the third embodiment.

### DESCRIPTION OF EMBODIMENTS

### First Embodiment

A mass spectrometer of a first embodiment, which is an example of an ion analyzer according to the present invention, will be described below with reference to the drawings. The ion analyzer of the first embodiment is an ion trap-time-of-flight (IT-TOF) mass spectrometer.

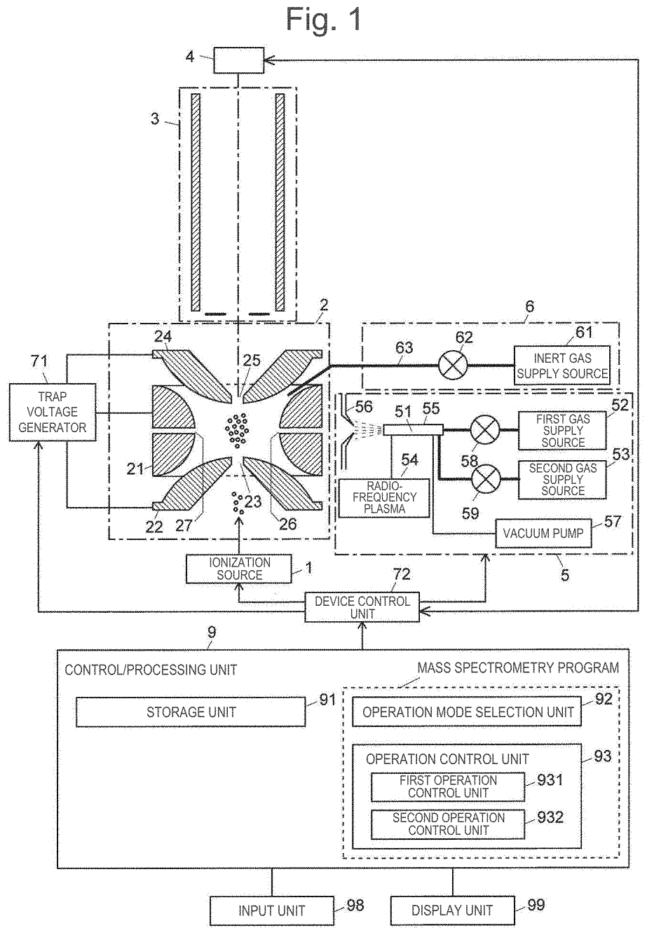

FIG. 1 illustrates a schematic configuration of the ion trap-time-of-flight mass spectrometer (which is simply referred to as “mass spectrometer” hereinafter) of the first embodiment. The mass spectrometer of the first embodiment includes an ionization source 1 which ionizes components in a sample, an ion trap 2 which traps ions generated by the ionization source 1 by the action of a radio-frequency electric field, a time-of-flight mass separator 3 which separates ions ejected from the ion trap 2 according to a mass-to-charge ratio, and an ion detector 4 which detects the separated ions, in a vacuum chamber (not illustrated) maintained in a vacuum atmosphere. The ion trap mass spectrometer of the first embodiment further includes a radical generation/irradiation unit 5 (corresponding to a radical generation unit and a radical introduction unit in the present invention) for irradiating precursor ions trapped in the ion trap 2 with radicals in order to dissociate the ions trapped in the ion trap 2, an inert gas supplier 6, a trap voltage generator 71, a device control unit 72, and a control/processing unit 9.

As the ionization source 1 of the mass spectrometer of the first embodiment, an ionization source suitable for ionization of a sample component, such as an ESI source or a MALDI source, can be used. The ion trap 2 of the first embodiment is a three-dimensional ion trap including an annular ring electrode 21 and a pair of endcap electrodes (inlet-side endcap electrode 22 and outlet-side endcap electrode 24) arranged to face each other with the ring electrode 21 interposed therebetween. A radical particle introduction port 26 and a radical particle releasing port 27 are formed in the ring electrode 21, an ion introduction hole 23 is formed in the inlet-side endcap electrode 22, and an ion ejection hole 25 is formed in the outlet-side endcap electrode 24. In response to an instruction from the device control unit 72, the trap voltage generator 71 applies one of a radio-frequency voltage and a direct-current voltage or a combined voltage thereof to each of the ring electrode 21, the inlet-side endcap electrode 22, and the outlet-side endcap electrode 24 at a predetermined timing.

The radical generation/irradiation unit 5 includes a nozzle 55 in which a radical generation chamber 51 is formed, a vacuum pump (evacuation unit) 57 which evacuates the radical generation chamber 51, and an inductively coupled radio-frequency plasma source 54 which supplies microwaves for generating vacuum discharge in the radical generation chamber 51. The frequency of the microwaves is, for example, 2.45 GHz. A skimmer 56 is provided on an exit side of the nozzle 55.

The radical generation/irradiation unit 5 further includes a first gas supply source 52 which supplies a gas (first gas) as a raw material for radicals, and a second gas supply source 53 which supplies a gas (second gas) for refreshing an inside of the radical generation chamber 51. A valve 58 for adjusting a flow rate of the first gas is provided in a flow path from the first gas supply source 52 to the radical generation chamber 51. Further, similarly, a valve 59 for adjusting a flow rate of the second gas is provided in a flow path from the second gas supply source 53 to the radical generation chamber 51.

As the first gas, one that generates a kind of radical corresponding to a position at which precursor ions derived from the sample component are to be dissociated is used. Such radicals can include, for example, at least one of hydroxyl radicals, oxygen radicals, nitrogen radicals, and hydrogen radicals. Examples of raw material gases capable of generating such radicals include oxygen gas, nitrogen gas, water vapor, and air. These gases are preferable as raw material gases from the viewpoint of being inexpensive and safe to handle. However, usable raw material gases and radical species are not limited to these examples. It is also possible to generate radicals from various gases such as chlorides, sulfur compounds, fluorides, hydroxides, oxides, and carbides, and use the radicals for the dissociation reaction.

As the second gas, any of an oxygen gas, an ozone gas, a nitrogen gas, a gas of a compound containing an oxygen atom or a nitrogen atom, and a rare gas is used.

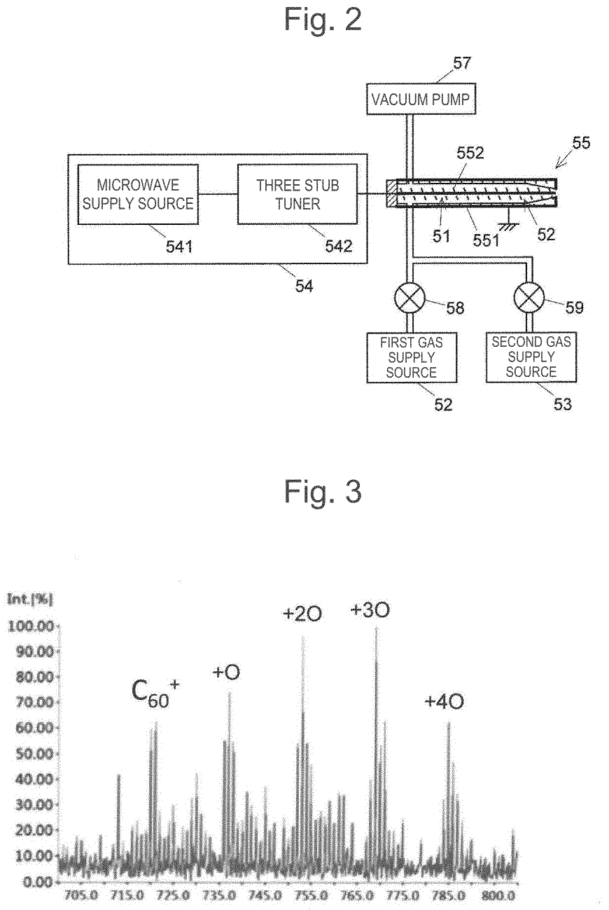

As illustrated in FIG. 2, the nozzle 55 has a tubular body 551 made of an electrical insulator, and an internal space thereof serves as a radical generation chamber 51. As the electrical insulator, for example, a metal oxide or a metal nitride such as aluminum oxide, magnesium oxide, zirconium oxide, boric oxide, sodium oxide, potassium oxide, silicon dioxide, and aluminum nitride can be used. The metal in the present specification may include silicon. A spiral antenna 552 (broken line in FIG. 2) is wound around the outer periphery of the tubular body 551. In the spiral antenna 552 of the present embodiment, a conductive coil is wound 15 times. For example, a tungsten coil can be used for the spiral antenna 552. The material and the number of windings of the spiral antenna 552 are examples, and can be appropriately modified. Further, a radio-frequency plasma source 54 including a microwave supply source 541 and a three stub tuner 542 is connected to the nozzle 55, and radio-frequency power is supplied from the radio-frequency plasma source 54 to the spiral antenna 552. In the first embodiment, the radio-frequency plasma source 54 which generates plasma by inductively coupled radio-frequency discharge is used, but plasma can be generated by various kinds of conventionally known radio-frequency discharge such as capacitively coupled type.

The inert gas supplier 6 includes an inert gas supply source 61 which supplies an inert gas (For example, helium gas, nitrogen gas, argon, and the like) used as a buffer gas, a cooling gas, or the like, a valve 62 capable of adjusting a flow rate, and a gas introduction pipe 63.

The control/processing unit 9 includes an operation mode selection unit 92 and an operation control unit 93 as functional blocks in addition to the storage unit 91. The operation control unit 93 includes a first operation control unit 931 which controls a measurement operation and a second operation control unit 932 which controls a maintenance operation, and these functional blocks are embodied by executing a mass spectrometry program installed in advance. The entity of the control/processing unit 9 is a general computer, and an input unit 98 and a display unit 99 are connected.

In response to a control signal from the operation control unit 93 of the control/processing unit 9, the device control unit 72 controls operations of the ionization source 1, the trap voltage generator 71, the radical generation/irradiation unit 5, the inert gas supplier 6, and the like.

Next, a first operation (measurement operation) and a second operation (maintenance operation) in the mass spectrometer of the first embodiment will be described. When the user executes the mass spectrometry program, the operation mode selection unit 92 displays selection screens for the first operation mode (measurement) and the second operation mode (maintenance) on the display unit 99. When the first operation mode is selected, a predetermined control signal is transmitted from the first operation control unit 931 to the device control unit 72, and each unit is controlled to perform the first operation. Furthermore, when the second operation mode is selected, a predetermined control signal is transmitted from the second operation control unit 932 to the device control unit 72, and each unit is controlled to perform the second operation.

When the user selects the first operation mode, the vacuum chamber accommodating the ionization source 1 and the like is evacuated to a predetermined degree of vacuum by a vacuum pump (not illustrated). Further, the radical generation chamber 51 is also evacuated to a predetermined degree of vacuum by the vacuum pump 57. Subsequently, the first gas is supplied from the first gas supply source 52 to the radical generation chamber 51 of the radical generation/irradiation unit 5. Then, radio-frequency power (microwave) is supplied from the radio-frequency plasma source 54 to the spiral antenna 552, and radicals are generated inside the radical generation chamber 51.

Various ions (mainly monovalent ions) generated from a sample such as a peptide mixture in the ionization source 1 are ejected from the ionization source 1 in a packet shape, and introduced into the inside of the ion trap 2 through the ion introduction hole 23 formed in the inlet-side endcap electrode 22. The peptide-derived ions introduced into the ion trap 2 are trapped by a radio-frequency electric field formed in the ion trap 2 by a voltage applied from the trap voltage generator 71 to the ring electrode 21. Thereafter, a predetermined voltage is applied from the trap voltage generator 71 to the ring electrode 21 and the like, whereby ions included in a mass-to-charge ratio range other than ions having a target specific mass-to-charge ratio are excited and excluded from the ion trap 2. Thus, precursor ions having a specific mass-to-charge ratio are selectively captured in the ion trap 2.

Subsequently, the valve 62 of the inert gas supplier 6 is opened, and an inert gas such as helium gas is introduced into the ion trap 2 from the inert gas supply source 61. As a result, the precursor ions are cooled and converged to the vicinity of the center of the ion trap 2. Thereafter, the valve 58 of the radical generation/irradiation unit 5 is opened, and the first gas is supplied to the radical generation chamber 51 to generate radicals. The generated radicals are ejected from the tip of the nozzle 55, and the precursor ions trapped in the ion trap 2 are irradiated with the radicals.

The opening degree and the like of the valve 58 are maintained in a constant state, and the ions are irradiated with radicals at a predetermined flow rate. Further, an irradiation time of the radicals to the precursor ions is also set appropriately. The valve 58 is opened and closed according to the irradiation time, or the supply of microwaves is started and stopped. The opening degree of the valve 58 and the radical irradiation time can be determined in advance based on the results of preliminary experiments and the like. When the radicals are irradiated, unpaired electron-induced dissociation occurs in the precursor ions, and product ions are generated. Various product ions generated are captured in the ion trap 2 and cooled by helium gas or the like from the inert gas supplier 6. Thereafter, a DC voltage is applied from the trap voltage generator 71 to the inlet-side endcap electrode 22 and the outlet-side endcap electrode 24 at a predetermined timing, and the potential gradient generated by this accelerates ions trapped in the ion trap 2, and the ions are simultaneously ejected through the ion ejection holes 25. The product ions generated here may include both fragment ions and adduct ions.

The product ions ejected from the ion trap 2 are introduced into the flight space of the time-of-flight mass separator 3 and separated according to the mass-to-charge ratio while flying in the flight space. The ion detector 4 sequentially detects the separated ions. The control/processing unit 9 receives a signal of this detection and creates a time-of-flight spectrum in which the time of emission of the ions from the ion trap 2 is set to zero, for example. Then, a product ion spectrum is created by converting the flight time into a mass-to-charge ratio using mass calibration information obtained in advance. The control/processing unit 9 identifies components in the sample by performing predetermined data processing based on information (mass information) obtained from the mass spectrum, and the like.

When the user selects the second operation mode, the operation mode selection unit 92 displays selection screens of the normal mode and the short-time mode on the display unit 99. When the user selects the normal mode, the valve 59 is opened, and the second gas is fed into the tubular body 551. The valve 59 is opened for a predetermined time, during which the second gas continues to flow inside the tubular body 551. Alternatively, waiting may be performed for a predetermined time in a state where the air inside the tubular body 551 is replaced with the second gas.

In the first operation mode, vacuum discharge is generated inside the tubular body 551 made of an electrical insulator, and radicals are generated from the first gas. While this operation is repeatedly performed, the metal is deposited on the inner wall surface of the tubular body 551 by the discharge. When the first operation mode is performed in a state where a large amount of metal is deposited on the inner wall surface of the tubular body 551, radicals generated inside the tubular body 551 adhere to the metal and disappear, and the amount of radicals introduced into the ion trap 2 decreases. This means a decrease in the amount of radicals irradiated to the precursor ions derived from the sample components, and thus the dissociation efficiency of the precursor ions deteriorates and the amount of product ions generated decreases.

The second operation mode is a maintenance mode performed to solve the above problem. In the normal mode, the second gas is circulated inside the tubular body 551. As described above, the second gas is, for example, any of an oxygen gas, an ozone gas, a nitrogen gas, a gas of a compound containing an oxygen atom or a nitrogen atom, and a rare gas. When the second gas other than the rare gas is introduced into the tubular body 551, the metal deposited on the inner wall surface of the tubular body 551 is bonded to an oxygen atom or a nitrogen atom to be changed to a metal oxide or a metal nitride. When the rare gas as the second gas is introduced into the tubular body 551, atoms can collide with the inner wall surface of the insulating tube to remove the deposited metal. Therefore, it is possible to suppress the disappearance of radicals inside the tubular body 551 at the time of measurement in the first operation mode. The execution time of the normal mode and the opening degree of the valve 59 may be appropriately determined according to the degree of decrease in the detection sensitivity of product ions in the first operation mode (the amount of disappearance of radicals in the tubular body 551). The relationship between the degree of decrease in detection sensitivity and the execution time of the normal mode can be derived by, for example, performing a preliminary experiment.

On the other hand, when the user selects the short-time mode, the radical generation chamber 51 is evacuated to a predetermined degree of vacuum by the vacuum pump 57. Subsequently, the second gas is supplied from the second gas supply source 53 to the inside of the tubular body 551. When radio-frequency power (microwave) is supplied from the radio-frequency plasma source 54 to the spiral antenna 552, radicals are generated in the radical generation chamber 51. The radicals generated from the second gas other than the rare gas include oxygen radicals or nitrogen radicals. Since the oxygen radical and the nitrogen radical have higher reactivity than the second gas itself (non-radical species), the oxygen radical and the nitrogen radical are bonded to the metal precipitated on the inner wall surface of the tubular body 551 in a shorter time than in the normal mode, and the metal can be changed into a metal oxide or a metal nitride. When a rare gas is used as the second gas, monatomic ions of the rare gas having a relatively large mass value collide with metal deposited on the inner wall surface of the tubular body 551, and the metal is removed.

If molecules of the first gas adhere to the inner wall surface of the tubular body 551 before radical generation in the first operation mode is performed, radicals are also generated from these molecules when the first operation mode is executed, and the amount of radical generation increases. As a result, the amount of radicals irradiated to the precursor ions derived from the sample components increases, and the dissociation efficiency of the precursor ions increases, so that the amount of product ions generated increases. This effect is remarkable, for example, when the first gas is water vapor. However, when the discharge is repeated, the amount of molecules of the first gas adhering to the inner wall surface of the tubular body 551 decreases, the effect thereof is weakened, and the amount of product ions to be generated decreases. Therefore, the inner wall surface of the tubular body 551 is preferably a rough surface or a porous surface. As a result, molecules of the first gas easily adhere to the inner wall surface of the tubular body 551. Further, the surface area of the inner wall surface of the tubular body 551 increases, and the amount of molecules which can be attached increases. The rough surface and the porous surface can be formed by, for example, surface treatment using sandpaper or the like.

Here, measurement results performed by the inventors in the mass spectrometer of the first embodiment will be described.

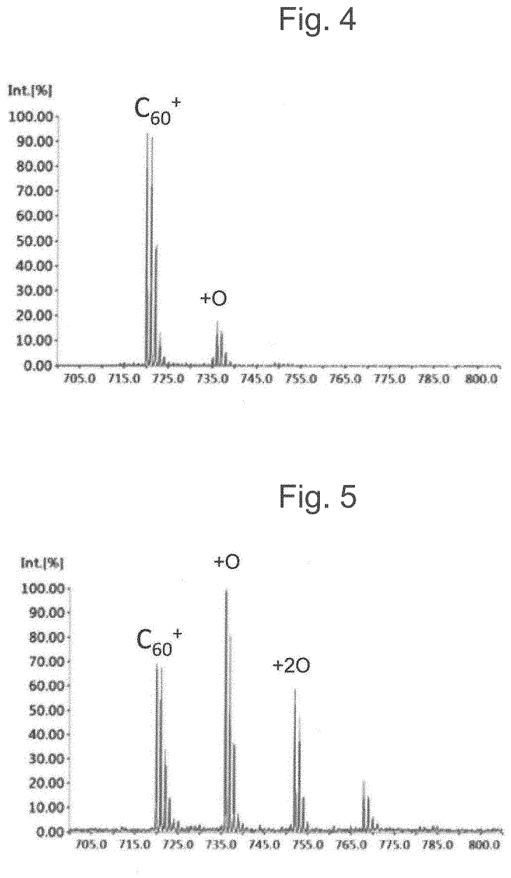

FIGS. 3 to 5 are mass spectra of product ions (oxygen added ions) obtained by irradiating precursor ions derived from fullerene trapped in the ion trap 2 with radicals obtained by radio-frequency discharge using water as a raw material gas. FIG. 3 illustrates a result in a case where the tubular body 551 is a new aluminum oxide tube, and it can be confirmed that a large number of oxygen radicals are attached. FIG. 4 is a measurement result after the discharge is repeated several hundred times. It is found that only about one oxygen radical is attached to the precursor ion derived from fullerene, and the radical generation efficiency is deteriorated.

FIG. 5 is a measurement result after introducing oxygen gas into the tubular body 551 and discharging with weak electric power of several W for 5 minutes. Compared with FIG. 4, the amount of oxygen radicals attached to the precursor ions is increased. That is, the amount of radicals generated by the radical generation/irradiation unit 5 and irradiated on the precursor ions derived from fullerene in the ion trap 2 is recovered. This is considered to be because, as described above, oxygen was bonded to the metal (here, aluminum) precipitated on the inner wall surface of the tubular body 551 made of an insulator (here, alumina), so that the inner wall surface was restored to aluminum oxide (Al₂O₃). In this measurement, oxygen radicals are generated by the discharge of oxygen gas, but the same result can be obtained by discharging a raw material gas such as water or nitrogen oxide in which oxygen radicals can be generated. Further, although the time required for restoration is long, the same effect can be obtained even in the normal mode in which oxygen gas or water vapor is introduced into the alumina tube without discharging. Furthermore, the same results as described above were obtained by discharging a rare gas such as argon gas or xenon gas. This is considered to be because ions and electrons generated by the discharge of the rare gas collide with the inner wall surface, and the metal deposited on the inner wall surface is removed.

### Second Embodiment

Next, a mass spectrometer of a second embodiment, which is another example of the ion analyzer according to the present invention, will be described below with reference to the drawings. The mass spectrometer of the second embodiment is a triple quadrupole mass spectrometer.

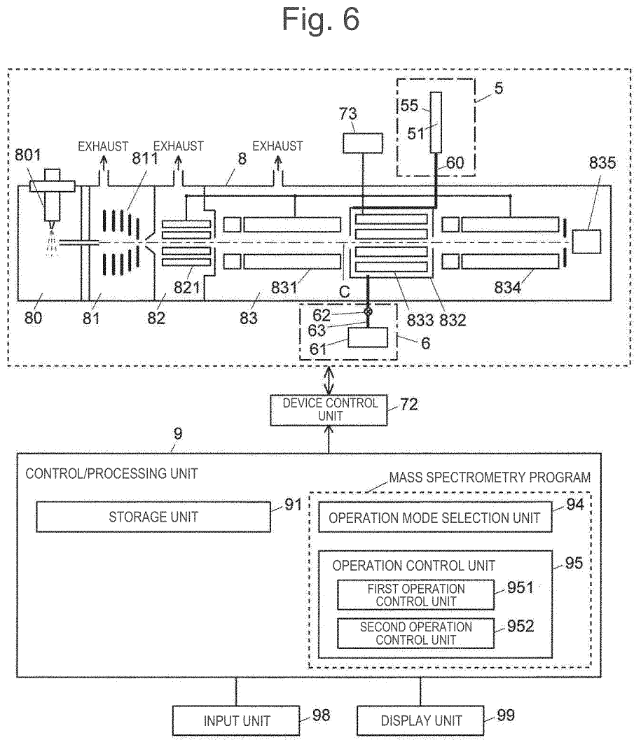

FIG. 6 is a schematic configuration diagram of a mass spectrometer of the second embodiment. The mass spectrometer of the second embodiment has a configuration of a multi-stage differential exhaust system including a first intermediate vacuum chamber 81 and a second intermediate vacuum chamber 82 between an ionization chamber 80 at substantially atmospheric pressure and a high-vacuum analysis chamber 83 evacuated by a vacuum pump (not illustrated) in which the degree of vacuum is increased stepwise. These are accommodated in a chamber 8. An ionization source 801 is disposed in the ionization chamber 80. As the ionization source 801, for example, an ESI probe is used. In order to transport the ions to the subsequent stage while converging the ions, an ion guide 811 is installed in the first intermediate vacuum chamber 81, and an ion guide 821 is installed in the second intermediate vacuum chamber 82. In the analysis chamber 83, a front-stage quadrupole mass filter 831 which separates ions according to a mass-to-charge ratio, a collision cell 832 in which a multipole ion guide 833 is installed, a rear-stage quadrupole mass filter 834 which separates ions according to a mass-to-charge ratio, and an ion detector 835 are installed.

All of the ion guides 811 and 821, the front-stage quadrupole mass filter 831, the multipole ion guide 833, and the rear-stage quadrupole mass filter 834 function as an ion guide or a mass filter when a predetermined radio-frequency voltage or direct-current voltage is applied. As these electrodes, metal electrodes are usually used. In many cases, stainless steel is used. Further, a metal material plated with gold or platinum is preferably used. A heater 73 is connected to the ion guides 811 and 821, the front-stage quadrupole mass filter 831, the multipole ion guide 833, and the rear-stage quadrupole mass filter 834. Here, the heater 73 is connected to all metal electrodes, but may be connected only to the multipole ion guide 833 in the collision cell 832. As the heater 73 for heating these electrodes, for example, a polyimide heater can be used.

Although FIG. 6 illustrates the configuration in which the ion guides 811 and 821, the front-stage quadrupole mass filter 831, the multipole ion guide 833, and the rear-stage quadrupole mass filter 834 are heated by the heater 73, it is also possible to adopt a configuration in which an infrared lamp is arranged inside the collision cell 832 or the like and the multipole ion guide 833 or the like in the collision cell 832 is radiationally heated. Further, it is also possible to adopt a configuration in which a window portion which transmits infrared rays is provided in the collision cell 832, and the multipole ion guide 833 and the like are radiationally heated from the outside of the collision cell 832 through the window portion. Of course, not only the infrared lamp but also a laser light source and an LED light source can be used. Furthermore, it is also possible to radiationally heat each electrode with light in a wavelength band other than infrared rays. By adopting the configuration of radiationally heating the electrode, the electrode can be heated in a non-contact manner.

The radical generation/irradiation unit 5 has the same configuration as that of the first embodiment, but is different in that a transport pipe 60 is provided at an outlet end of the nozzle 55. A distal end portion of the transport pipe 60 on a side opposite to the nozzle 55 is disposed along a wall surface of the collision cell 832. As the transport pipe 60, for example, one made of an insulator is used. Examples of such an insulator include metal oxides and metal nitrides such as aluminum oxide (alumina), magnesium oxide, zirconium oxide, boric oxide, sodium oxide, potassium oxide, silicon dioxide, and aluminum nitride.

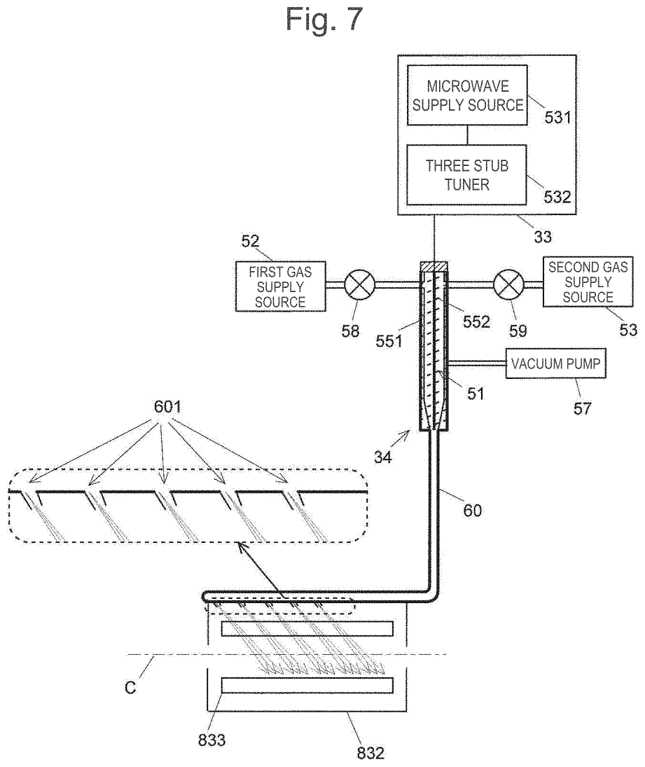

Further, the radical generation/irradiation unit 5 includes a first gas supply source 52 and a second gas supply source 53 (not illustrated in FIG. 6) as in the first embodiment. However, the first gas in the second embodiment is a gas having oxidizing ability, and is, for example, an oxygen gas, an ozone gas, or a gas containing a compound containing an oxygen atom (for example, water). Further, the second gas in the second embodiment is a gas having a reducing ability. Examples of the gas having reducing ability include hydrogen gas, nitrogen gas, and a compound containing a hydrogen atom, a nitrogen atom, or an oxygen atom such as carbon monoxide. In FIGS. 6 and 7, the first gas and the second gas are introduced into the same radical generation chamber 51, but the radical generation chamber 51 into which the first gas and the second gas are introduced may be individually provided by using two nozzles 55.

As illustrated in FIG. 7, five head units 601 are provided in a part of the transport pipe 60 disposed along the wall surface of the collision cell 832. Each of the head units 601 is provided with an inclined cone-shaped injection port, and radicals are injected in a direction intersecting a flight direction of ions (ion optical axis C). This increases a chance of contact between the ions flying along the ion optical axis C and the radicals, and more radicals can be attached to the precursor ions. In this embodiment, the injection port is provided so as to inject radicals in the same direction from each of the head units 601, but radicals may be injected in different directions from each of the head units 601, and the radicals may be evenly injected to the entire internal space of the collision cell 832. The number and shape of the head units 601 are merely examples, and can be appropriately changed according to the length and the like of the collision cell 832.

The inert gas supplier 6 has the same configuration as that of the first embodiment (FIG. 6 illustrates only the inert gas supply source 61 and the gas introduction pipe 63). In the measurement example described below, since unpaired electron-induced dissociation occurs in precursor ions by irradiation with radicals, the inert gas supplier 6 is not used. The inert gas supplier 6 is used when precursor ions derived from a sample component are dissociated by a collision induced dissociation (CID) method.

The control/processing unit 9 includes an operation mode selection unit 94 and an operation control unit 95 as functional blocks in addition to the storage unit 91. The operation control unit 95 includes a first operation control unit 951 which controls a measurement operation and a second operation control unit 952 which controls a maintenance operation, and these functional blocks are embodied by executing a mass spectrometry program installed in advance. The entity of the control/processing unit 9 is a general computer, and an input unit 98 and a display unit 99 are connected.

The device control unit 72 receives a control signal from the operation control unit 95 of the control/processing unit 9 and controls the operation of each unit.

Next, a first operation (measurement operation) and a second operation (maintenance operation) in the mass spectrometer of the second embodiment will be described. When the user executes the mass spectrometry program, the operation mode selection unit 94 displays selection screens for the first operation mode (measurement) and the second operation mode (maintenance) on the display unit 99. When the first operation mode is selected, a predetermined control signal is transmitted from the first operation control unit 951 to the device control unit 72, and each unit is controlled to perform the first operation. Further, when the second operation mode is selected, a predetermined control signal is transmitted from the second operation control unit 952 to the device control unit 72, and each unit is controlled to perform the second operation.

When the user selects the first operation mode, the first intermediate vacuum chamber 81, the second intermediate vacuum chamber 82, and the analysis chamber 83 in the chamber 8 are evacuated to a predetermined degree of vacuum by a vacuum pump (not illustrated). Further, the radical generation chamber 51 (inside the nozzle 55) is also evacuated to a predetermined degree of vacuum by the vacuum pump 57. Subsequently, the first gas is supplied from the first gas supply source 52 to the radical generation chamber 51 of the radical generation/irradiation unit 5. Then, radio-frequency power (microwave) is supplied from the radio-frequency plasma source 54 to the spiral antenna 552, and radicals are generated inside the radical generation chamber 51.

Various ions generated from the sample in the ionization source 801 are converged by the ion guide 811 in the first intermediate vacuum chamber 81 and the ion guide 821 in the second intermediate vacuum chamber 82, and enter the analysis chamber 83. In the analysis chamber 83, ions having a predetermined mass-to-charge ratio are selected as precursor ions by the front-stage quadrupole mass filter 831.

The valve 58 of the radical generation/irradiation unit 5 is opened in accordance with (or before) the timing at which the precursor ions having passed through the front-stage quadrupole mass filter 831 enter the collision cell 832, and the first gas is supplied to the radical generation chamber 51 to generate radicals. The generated radicals are ejected into the collision cell 832 through the transport pipe 60 and the head unit 601, and the precursor ions flying in the collision cell 832 are irradiated with the radicals.

The opening degree and the like of the valve 58 are maintained in a constant state, and the ions are irradiated with radicals at a predetermined flow rate. The opening degree of the valve 58 can be determined in advance on the basis of the result of the preliminary experiment or the like according to the time or the like during which the precursor ions fly in the collision cell 832. When the radicals are irradiated, unpaired electron-induced dissociation occurs in the precursor ions, and product ions are generated. The generated various product ions enter the rear-stage quadrupole mass filter 834, are subjected to mass separation, and then are detected by the ion detector 835.

When the user selects the second operation mode, the operation mode selection unit 94 displays selection screens of the normal mode and the short-time mode on the display unit 99. When the user selects the normal mode, the valve 59 is released by the second operation control unit 952, and the second gas is fed into the collision cell 832. The second gas introduced into the collision cell 832 flows out into the chamber 8 from the inlet and the outlet of the collision cell 832. Further, in parallel with this, the second operation control unit 952 operates the heater 73 (or a radiant light source such as an infrared lamp. Hereinafter, the description of the radiant light source is omitted) to heat each electrode to a predetermined temperature.

In the first operation mode, radicals generated from the first gas are introduced into the collision cell 832. As described above, the first gas is a gas having oxidizing ability, and is, for example, an oxygen gas, an ozone gas, or a gas containing a compound containing an oxygen atom (for example, water). Oxygen radicals and hydroxy radicals are generated from these gases and introduced into the collision cell 832. When oxygen radicals and hydroxy radicals are repeatedly introduced into the collision cell 832, the surface of the multipole ion guide 833 in the collision cell 832 is oxidized. Further, the surfaces of other electrodes can also be oxidized by radicals flowing out from the inlet and the outlet of the collision cell 832.

When the measurement in the first operation mode is repeatedly performed, oxidation of the electrode surface proceeds. Many of the metal oxides are insulators, and when an insulating film is formed on the electrode surface, undesired charge-up occurs when a voltage is applied. When the measurement in the first operation mode is performed in such a state, an intended electric field is not formed even if a predetermined radio-frequency voltage or a predetermined DC voltage is applied thereto. As a result, the operation accuracy of the ion guide and the mass filter deteriorates, and the detection sensitivity of product ions or the mass accuracy deteriorates.

The second operation mode is a maintenance mode performed to solve the above problem. In the normal mode, a gas having a reducing power is introduced into the collision cell 832. As described above, the second gas contains a gas having a reducing ability such as hydrogen gas or nitrogen gas. When the second gas is introduced into the collision cell 832, the surface of the oxidized metal electrode is reduced. As a result, an insulator (metal oxide) on the electrode surface is removed, and a desired electric field is formed again when a voltage is applied. This effect is particularly remarkable in the electrodes in the collision cell 832, but the same effect can be obtained for electrodes located at other places.

Further, in the second embodiment, each electrode is heated by the heater 73 in order to promote the reduction reaction of the metal oxide. This temperature is, for example, 50° C. or higher, preferably 75° C. or higher, more preferably 100° C. or higher, still more preferably 125° C. or higher, and still more preferably 150° C. or higher.

The sample molecules introduced into the collision cell 832 may adhere to the electrode surface, and the sample molecules may be irradiated with radicals to form an insulating film. For example, when an organic sample is measured, an organic insulator such as polyvinyl alcohol can be formed. Since polyvinyl alcohol and the like are modified at about 50° C., such an insulator can be removed when the electrode is heated to 50° C. or higher by the heater 73. Further, when a sample derived from a living body is measured, an insulator derived from a protein or the like can be formed. Since some proteins and the like are denatured at about 75° C., such insulants can also be removed when the electrode is heated to 75° C. or higher by the heater 73. Furthermore, when the temperature of the electrode is 100° C. or higher, the electrode surface is heated to the boiling point of water or higher to enhance the activity of the reaction for removing the insulating film, and when the temperature is 125° C. or higher, the electrode surface is heated to the boiling point of octane as a saturated hydrocarbon or higher to further enhance the activity of the reaction for removing the insulating film. When gold plating is applied to the electrode surface, gold oxide is formed on the electrode surface by the oxidation. Since gold oxide is decomposed at about 160° C., it is more preferable to heat the electrode to 160° C. or higher by the heater 73.

On the other hand, when the user selects the short-time mode, the radical generation chamber 51 is evacuated to a predetermined degree of vacuum by the vacuum pump 57. Subsequently, the second gas is supplied from the second gas supply source 53 to the radical generation chamber 51. When radio-frequency power (microwave) is supplied from the radio-frequency plasma source 54 to the spiral antenna 552, radicals are generated in the radical generation chamber 51. The radicals generated from the second gas include hydrogen radicals and nitrogen radicals having a reducing ability. Since hydrogen radicals and nitrogen radicals have higher reactivity than the second gas itself (non-radical species), the metal electrode surface can be reduced in a shorter time. Further, the reduction reaction of the metal oxide is further promoted by heating each electrode by the heater 73 as in the normal mode.

In the conventional MS/MS measurement in which precursor ions are dissociated by collision-induced dissociation, a collision gas (inert gas such as argon) is introduced from the inert gas supplier 6 into the collision cell 832 at about 0.1 Pa. It is known that when precursor ions passing through the collision cell 832 collide with collision gas, product ions are generated and stalled, and the time required for ions to pass through the collision cell 832 increases. It is known that an increase in the passage time of ions in the collision cell 832 leads to an increase in a so-called “Crosstalk”, leading to deterioration of the measurement throughput of the triple quadrupole mass spectrometer.

Patent Literature 2 describes that a DC electric field is formed in the collision cell 832 so as to accelerate ions which have stalled due to collision with collision gas toward the outlet of the collision cell 832 to shorten the passage time of the ions. However, as the measurement is repeated, ions derived from the sample component adhere to the surface of the multipole ion guide 833 in the collision cell 832 to form an insulating film, and the surface of the electrode is charged up. As a result, distortion occurs in the potential structure originally having a gradient in the exit direction, the flight speed of ions decreases, and the throughput of measurement decreases.

When radicals are introduced into the collision cell 832 as in the above embodiment, an insulating film can be similarly formed on the electrode surface. Rather, the inventors' experiments have revealed that the rate at which the insulating film is formed is faster than in conventional MS/MS measurement, resulting in similar performance degradation in a shorter time than would be expected in conventional MS/MS measurement.

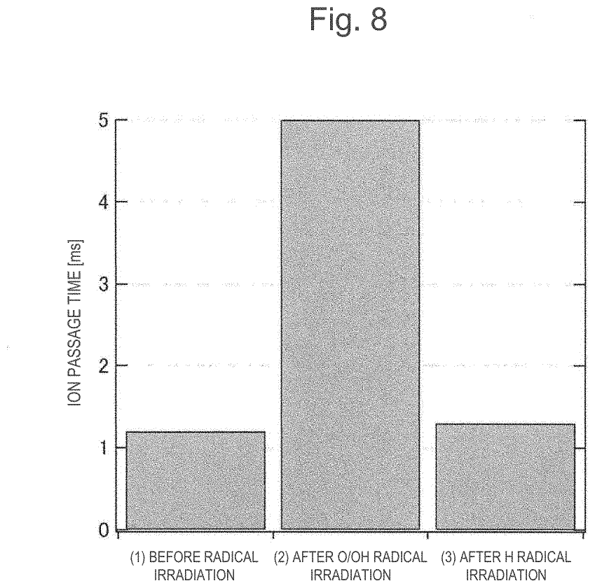

Here, the results of experiments conducted by the present inventors are shown. FIG. 8 illustrates the time taken for ions to pass through the collision cell 832 of the triple quadrupole mass spectrometer after (1) removing the oxide film from the electrode surface in the collision cell 832, (2) irradiating the inside of the collision cell 832 with oxygen radicals and hydroxy radicals for 1 minute, (3) irradiating the inside of the collision cell 832 with oxygen radicals and hydroxy radicals for 1 minute, and subsequently irradiating the inside of the collision cell 832 with hydrogen radicals.

From the comparison between (1) and (2), it can be seen that as a result of irradiating the collision cell 832 with oxygen radicals and hydroxy radicals for 1 minute, an oxidation (insulating) film is formed on the electrode surface of the multipole ion guide 833 in the collision cell 832, thereby extending the passage time of ions by 4 times or more. This means that the measurement throughput decreases up to about four times.

Further, from the comparison of (1) to (3), it can be seen that by introducing hydrogen radicals into the collision cell 832 for 1 minute, the state is refreshed to the same state as before the irradiation of oxygen radicals and hydroxy radicals. This is considered to be because the oxide film formed on the electrode surface was reduced by hydrogen radicals, and the charge-up on the electrode surface was reduced.

In the measurement example of FIG. 8, the quadrupole electrode made of SUS 304 is used as the ion guide in the collision cell 832, but the same effect can be expected with other stainless steel materials. Further, in another measurement performed by the present inventors, an effect of suppressing charge-up due to oxidation of the electrode surface was observed by forming the electrode with a noble metal which is hardly oxidized such as gold, silver, copper, and platinum, or coating the surface with a noble metal. Further, platinum and palladium are known to have high hydrogen adsorption capability, and it is known that these metals have a catalytic effect of dissociating hydrogen molecules into hydrogen atoms on the surface thereof Therefore, by using an electrode made of these metals having a high hydrogen occlusion capability or coating the surface with these metals, a refresh effect of removing the oxide film on the metal surface in a short time can be obtained only by introducing hydrogen molecules. Further, as described above, the electrode is heated by heater 73 during the second operation, so that the refresh effect can be further enhanced.

In the second embodiment, the first gas and the second gas respectively supplied from the first gas supply source 52 and the second gas supply source 53 may be the same. For example, carbon dioxide is a compound containing an oxygen atom, and has a characteristic as a first gas in that an oxygen radical having an oxidizing ability is generated, and has a characteristic as a second gas in that carbon monoxide (or a radical thereof) having a reducing ability can be generated. Further, water vapor is a compound containing an oxygen atom, and has characteristics as a first gas in that oxygen radicals and hydroxy radicals having oxidation ability are generated, and has characteristics as a second gas in that hydrogen (or hydrogen radicals) having reduction ability can be generated. When the same gas is used as the first gas and the second gas, the second operation mode may be executed under a condition (Heating temperature, presence or absence of radicalization, and the like) in which the reducibility is stronger than the condition when the gas is used as the first gas when the gas is used as the second gas.

### Third Embodiment

Next, a mass spectrometer of a third embodiment, which is another example of the ion analyzer according to the present invention, will be described below with reference to the drawings. The mass spectrometer of the third embodiment is a triple quadrupole mass spectrometer.

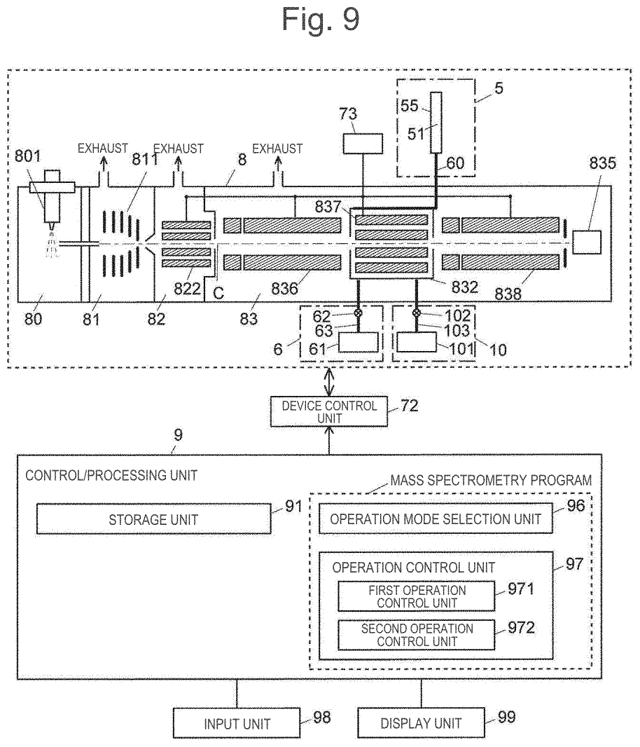

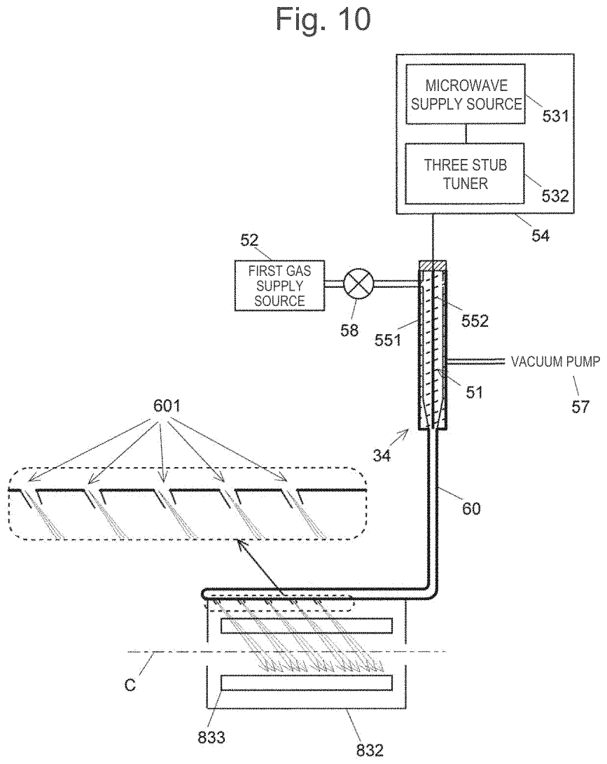

FIG. 9 is a schematic configuration diagram of a mass spectrometer of the third embodiment. Components common to those of the mass spectrometer of the second embodiment are denoted by the same reference signs as those of the mass spectrometer of the second embodiment, and description thereof is appropriately omitted.

One of the features of the mass spectrometer of the third embodiment is that the surfaces of the respective electrodes constituting an ion guide 822 arranged in the second intermediate vacuum chamber 82, a front-stage quadrupole mass filter 836 arranged in the analysis chamber 83, an ion guide 837, and a rear-stage quadrupole mass filter 838 are coated with gold (the surface of the rod electrode made of stainless steel is coated with gold). A heater 73 is connected to these electrodes similarly to the mass spectrometer of the second embodiment. In FIG. 9, the heater 73 is connected to all of the above electrodes, but may be connected only to the multipole ion guide 837 in the collision cell 832. As the heater 73 for heating these electrodes, for example, a polyimide heater can be used.

Also in the mass spectrometer of the third embodiment, similarly to the second embodiment, it is also possible to adopt a configuration in which an infrared lamp is arranged inside the collision cell 832 or the like and the multipole ion guide 833 or the like in the collision cell 832 is radiationally heated. Further, it is also possible to adopt a configuration in which a window portion which transmits infrared rays is provided in the collision cell 832, and the multipole ion guide 833 and the like are radiationally heated from the outside of the collision cell 832 through the window portion. Of course, not only the infrared lamp but also a laser light source and an LED light source can be used. Furthermore, it is also possible to radiationally heat each electrode with light in a wavelength band other than infrared rays. By adopting the configuration of radiationally heating the electrode, the electrode can be heated in a non-contact manner.

As described later, in the third embodiment, the metal oxide formed on the surface of the electrode in the second operation is thermally decomposed. Therefore, in the third embodiment, a metal having a low decomposition temperature of the oxide film is used as the metal for coating the surface of the electrode. Such a metal having a low ionization tendency can be suitably used, and specifically, platinum, iridium, palladium, and silver can be suitably used in addition to gold. These oxides can be thermally decomposed at about 150° C.

Further, another feature of the mass spectrometer of the third embodiment is that a hydrogen gas supply unit 10 which supplies hydrogen gas into the collision cell 832 is provided. The hydrogen gas supply unit 10 includes a hydrogen gas supply source 101 for supplying hydrogen gas, a valve 102 capable of adjusting a flow rate, and a gas introduction pipe 103.

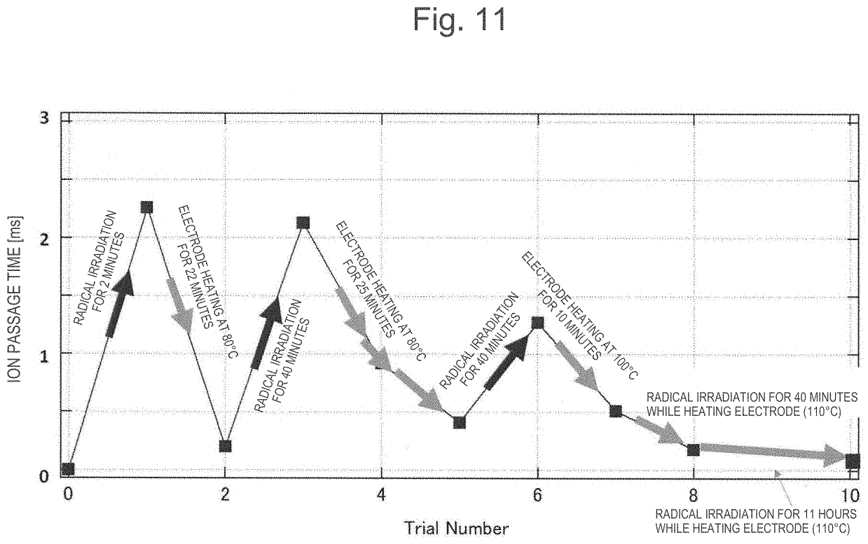

The mass spectrometer of the second embodiment includes the first gas supply source 52 which supplies a gas (first gas) as a radical raw material to the radical generation/irradiation unit 5 and the second gas supply source 53 which supplies a gas (second gas) for refreshing the inside of the radical generation chamber 51, but the mass spectrometer of the third embodiment includes only the first gas supply source 52 which supplies a gas (first gas) as a radical raw material as illustrated in FIG. 10. In the mass spectrometer of the third embodiment, a gas having oxidizing ability is supplied from the first gas supply source into the radical generation chamber 51, and radio-frequency plasma is supplied from the radio-frequency plasma source 54 to generate radicals. As the gas having oxidizing ability, for example, oxygen gas, water vapor, ozone gas, or carbon monoxide gas can be used. Further, these gases can be introduced into the collision cell 832 as they are without operating the radio-frequency plasma source 54. For example, when ozone gas is introduced into the collision cell 832 as it is, fragment ions in which a compound having an unsaturated hydrocarbon chain is cleaved at the position of a double bond are obtained.

The control/processing unit 9 includes an operation mode selection unit 96 and an operation control unit 97 as functional blocks in addition to the storage unit 91. The operation control unit 97 includes a first operation control unit 971 which controls a measurement operation and a second operation control unit 972 which controls a maintenance operation, and these functional blocks are embodied by executing a mass spectrometry program installed in advance. The entity of the control/processing unit 9 is a general computer, and an input unit 98 and a display unit 99 are connected.

The device control unit 72 receives a control signal from the operation control unit 95 of the control/processing unit 9 and controls the operation of each unit.

Next, a first operation (measurement operation) and a second operation (maintenance operation) in the mass spectrometer of the third embodiment will be described. When the user executes the mass spectrometry program, the operation mode selection unit 96 displays selection screens for the first operation mode (measurement) and the second operation mode (maintenance) on the display unit 99. When the first operation mode is selected, a predetermined control signal is transmitted from the first operation control unit 971 to the device control unit 72, and each unit is controlled to perform the first operation. Further, when the second operation mode is selected, a predetermined control signal is transmitted from the second operation control unit 972 to the device control unit 72, and each unit is controlled to perform the second operation.

When the user selects the first operation mode, the first intermediate vacuum chamber 81, the second intermediate vacuum chamber 82, and the analysis chamber 83 in the chamber 8 are evacuated to a predetermined degree of vacuum by a vacuum pump (not illustrated). Further, the radical generation chamber 51 (inside the nozzle 55) is also evacuated to a predetermined degree of vacuum by the vacuum pump 57. Subsequently, the first gas is supplied from the first gas supply source 52 to the radical generation chamber 51 of the radical generation/irradiation unit 5. Then, radio-frequency power (microwave) is supplied from the radio-frequency plasma source 54 to the spiral antenna 552, and radicals are generated inside the radical generation chamber 51.

Various ions generated from the sample in the ionization source 801 are converged by the ion guide 811 in the first intermediate vacuum chamber 81 and the ion guide 821 in the second intermediate vacuum chamber 82, and enter the analysis chamber 83. In the analysis chamber 83, ions having a predetermined mass-to-charge ratio are selected as precursor ions by the front-stage quadrupole mass filter 836.

The valve 58 of the radical generation/irradiation unit 5 is opened in accordance with (or before) the timing at which the precursor ions having passed through the front-stage quadrupole mass filter 836 enter the collision cell 832, and the first gas is supplied to the radical generation chamber 51 to generate radicals. The generated radicals are ejected into the collision cell 832 through the transport pipe 60 and the head unit 601, and the precursor ions flying in the collision cell 832 are irradiated with the radicals.

The opening degree and the like of the valve 58 are maintained in a constant state, and the ions are irradiated with radicals at a predetermined flow rate. The opening degree of the valve 58 can be determined in advance on the basis of the result of the preliminary experiment or the like according to the time or the like during which the precursor ions fly in the collision cell 832. When the radicals are irradiated, unpaired electron-induced dissociation occurs in the precursor ions, and product ions are generated. The generated various product ions enter the rear-stage quadrupole mass filter 838, are subjected to mass separation, and then are detected by the ion detector 835.

When the user selects the second operation mode, the operation mode selection unit 96 displays selection screens of the normal mode and the short-time mode on the display unit 99. When the user selects the normal mode, the second operation control unit 952 controls the heater 73 (or a radiant light source such as an infrared lamp. Hereinafter, the description of the radiant light source is omitted) to heat each electrode to a predetermined temperature. The predetermined temperature is a temperature at which the metal oxide (for example, gold oxide) formed on the electrode surface is thermally decomposed. The predetermined temperature may be determined in advance according to the type of electrode to be used (the type of metal on the electrode surface).

As described in the second embodiment, when a gas having oxidizing ability such as oxygen gas, ozone gas, or water vapor, or radicals generated from the gas are repeatedly introduced into the collision cell 832, the surface of the multipole ion guide 837 in the collision cell 832 is oxidized. Further, the radicals flowing out from the inlet and the outlet of the collision cell 832 may oxidize the surfaces of other electrodes (Electrodes constituting the ion guide 822 arranged in the second intermediate vacuum chamber 82, the front-stage quadrupole mass filter 836 and the rear-stage quadrupole mass filter 838 arranged in the analysis chamber 83) disposed in the space communicating with the collision cell 832.

When the measurement in the first operation mode is repeatedly performed, oxidation of the electrode surface proceeds. Many of the metal oxides are insulators, and when an insulating film is formed on the electrode surface, undesired charge-up occurs when a voltage is applied. When the measurement in the first operation mode is performed in such a state, an intended electric field is not formed even if a predetermined radio-frequency voltage or a predetermined DC voltage is applied thereto. As a result, the operation accuracy of the ion guide and the mass filter deteriorates, and the detection sensitivity of product ions or the mass accuracy deteriorates.

The second operation mode of the third embodiment is also a maintenance mode performed to solve the above problem similarly to the second operation mode of the second embodiment. In the normal mode, the respective electrodes constituting the ion guide 822 arranged in the second intermediate vacuum chamber 82, the front-stage quadrupole mass filter 836 arranged in the analysis chamber 83, the ion guide 837, and the rear-stage quadrupole mass filter 838 are heated to the predetermined temperature by the heater 73. As a result, the metal oxide formed on the surfaces of these electrodes is decomposed, and a desired electric field is formed again when a voltage is applied. This effect is particularly remarkable in the electrodes in the collision cell 832, but the same effect can be obtained for electrodes located at other places.

When the user selects the short-time mode, hydrogen gas is supplied from the hydrogen gas supply source 101 into the collision cell 832 in parallel with the above operation in the normal mode. In the short-time mode, by supplying hydrogen gas into the collision cell 832, thermal decomposition of the metal oxide can be promoted, and the metal oxide can be removed in a short time. Although the hydrogen gas is supplied here, the metal oxide can be thermally decomposed in a short time by using not only the hydrogen gas but also a gas having a reducing ability.

Next, a result of an experiment performed to confirm the effect of the maintenance mode of the third embodiment will be described. In this experiment, in the mass spectrometer of the third embodiment, the gold-plated ion guide 837 was disposed in the collision cell 832. Then, an operation (corresponding to a measurement operation) of introducing (irradiating) mixed radicals of hydroxy radicals and oxygen radicals generated from water vapor into the collision cell 832 and an operation (maintenance operation) of heating the collision cell 832 were repeated, and after completion of each operation, a time required for ions to pass through the collision cell 832 was measured.

FIG. 11 illustrates the transition of the passage time of ions. In the graph of FIG. 11, the vertical axis represents the passage time of ions in the collision cell, and the horizontal axis represents Trial Numbers assigned for convenience. The operation in each trial number is as follows.

Trial Number 1: After washing the ion guide 837, mixed radicals of hydroxy radicals and oxygen radicals were irradiated inside the collision cell 832 for 2 minutes (which is referred to as “irradiation with mixed radicals” hereinafter).

Trial Number 2: The ion guide 837 was heated at 80° C. for 22 minutes.

Trial Number 3: Irradiation of mixed radicals for 40 minutes.

Trial Numbers 4+5: The ion guide 837 was heated at 80° C. for 25 minutes.

Trial Number 6: Irradiation of mixed radicals for 40 minutes.

Trial Number 7: The ion guide 837 was heated at 100° C. for 10 minutes.

Trial Number 8: Mixed radicals were irradiated for 40 minutes while the ion guide 837 was heated to 110° C.

Trial Numbers 9+10: Mixed radicals were irradiated for 40 minutes while the ion guide 837 was heated to 110° C.

As can be seen from the transition of the passage time of the ions illustrated in FIG. 11, when the mixed radicals are continuously irradiated without heating the ion guide 837, the passage time of the ions becomes long. This is because an insulating film is formed on the surface of the electrode due to oxidation of the surface of the ion guide 837, and this insulating layer is unexpectedly charged up, so that the ion transport performance and the mass selection performance are deteriorated, and the increase in the ion passage time is caused by oxidation of the electrode, leading to deterioration of the measurement throughput.

For example, as can be seen from Trial Number 1, by irradiating the collision cell 832 with the mixed radicals for about 2 minutes without heating the ion guide 837, the passage time of the ions becomes longer than that before the irradiation of the mixed radicals of Trial Number 1 by 2 ms or more. On the other hand, as can be seen from Trial Number 2, the passage time of ions is recovered by heating at about 80° C. for 22 minutes. Further, as can be seen from Trial Numbers 8 to 10, when the ion guide 837 is heated to about 110° C., the passage time of the ions hardly changes even if the irradiation with the mixed radicals is continued, and rather, the thermal decomposition of the metal oxide on the electrode surface proceeds and the passage time of the ions is shortened. Therefore, in the first operation mode described above, each electrode may be further heated to a predetermined temperature.

The result illustrated in FIG. 11 shows a case where the electrode was gold-plated. In an experiment using a general stainless steel electrode as an ion guide, the passage time of ions was not recovered even when the temperature was heated from 80° C. to 150° C. Further, the results illustrated in FIG. 11 show oxidation of the electrode by mixed radicals of hydroxy radicals and oxygen radicals generated by water vapor discharge, but the same effect as described above is also expected in a case where a gas or radical having oxidizing ability such as ozone is introduced into the collision cell 832 (or other space where the electrode is disposed).

The above-described embodiments are merely examples and can be appropriately changed within the spirit of the present invention.

In the first embodiment, the ion trap-time-of-flight mass spectrometer is used, but the radical generation/irradiation unit 5, the control/processing unit 9, and the like similar to those in the first embodiment can also be used in a mass spectrometer having another configuration such as a triple quadrupole mass spectrometer. Further, the first embodiment and the second embodiment are mass spectrometers, but they can also be applied to an ion analyzer such as an ion mobility analyzer.

In the second embodiment and the third embodiment, the triple quadrupole mass spectrometer is used, but the radical generation/irradiation unit 5, the control/processing unit 9, the hydrogen gas supply unit 10, and the like similar to those in the second embodiment or the third embodiment can also be used in a mass spectrometer having another configuration such as an ion trap-time-of-flight type. Further, as the radical generation/irradiation unit in the second embodiment and the third embodiment, a unit which generates radicals by thermally dissociating a raw material gas can also be used. Further, in the second embodiment and the third embodiment, the case where the oxidation of the surface of the electrode made of metal and the formation of the insulating film occur by the measurement which causes the dissociation of the precursor ions derived from the sample component using the radicals has been described, but the same configuration as in the second embodiment and the third embodiment can also be applied to a case where the sample component adheres to the surface of the electrode made of metal and the metal is oxidized to form the insulating film by the measurement using another dissociation method such as collision-induced dissociation.

Furthermore, both the configurations of the first to third embodiments can be provided in one ion analyzer. In this case, for example, the control unit may be configured to execute a treatment of oxidizing metal atoms deposited on the inner wall surface of the insulating tube using the second gas described in the first embodiment and a treatment of reducing metal oxides formed on the electrode surface using the second gas described in the second embodiment and the heater 73 and the hydrogen gas supply unit 10 of the third embodiment.

[Modes]

It is understood by those skilled in the art that the plurality of exemplary embodiments described above are specific examples of the following aspects.

(Clause 1)

One aspect of the present invention is an ion analyzer configured to generate product ions from precursor ions derived from a sample component, and analyze the product ions, the ion analyzer including:

a reaction chamber into which the precursor ions are introduced;

a radical generation unit including an insulating tube, and a discharge unit configured to generate a discharge inside the insulating tube;

a gas supply unit capable of selectively supplying a first gas which is a gas serving as a raw material of radicals, and a second gas which is any of an oxygen gas, an ozone gas, a nitrogen gas, a gas of a compound containing an oxygen atom or a nitrogen atom, and a rare gas to an inside of the insulating tube;

an evacuation unit configured to evacuate the inside of the insulating tube;

a radical introduction unit configured to introduce radicals generated inside the insulating tube into an inside of the reaction chamber; and

a control unit configured to control operations of the radical generation unit, the gas supply unit, the evacuation unit, and the radical introduction unit, the control unit being configured to perform a first operation of introducing the first gas into the inside of the insulating tube in a state where the inside of the insulating tube is evacuated, generating radicals by generating a discharge, and introducing the radicals into the inside of the reaction chamber, and a second operation of introducing the second gas into the inside of the insulating tube.

In the ion analyzer of the clause 1, under the control of the control unit, the first operation of introducing the first gas into the inside of the insulating tube to generate radicals and introduce the radicals into the inside of the reaction chamber while supplying radio-frequency power to a coil in a state where the inside of the insulating tube is evacuated, and the second operation of introducing the second gas into the inside of the insulating tube are executed. This first operation is a measurement operation performed to generate product ions by reacting precursor ions derived from a sample component with radicals.

In the ion analyzer of the clause 1, in addition to the first operation, the second operation of introducing the second gas into the inside of the insulating tube at the time of non-measurement is performed. At this time, when any of an oxygen gas, an ozone gas, a nitrogen gas, and a gas of a compound containing an oxygen atom or a nitrogen atom is used as the second gas, the metal deposited on the inner wall surface of the insulating tube reacts with the oxygen atom or the nitrogen atom contained in the second gas, and the metal which eliminates the radicals changes to a metal oxide or a metal nitride, so that it is possible to suppress a decrease in the amount of the radicals introduced into the reaction chamber at the time of measurement and suppress deterioration of the detection sensitivity of the product ions. In addition, when a rare gas is used as the second gas, atoms of the rare gas collide with the inner wall surface of the insulating tube to remove deposited metal, and the same effect as described above can be obtained.

(Clause 2)

In the ion analyzer recited in the above-described clause 1, the second gas is water vapor or oxygen gas.

In the ion analyzer of the clause 2, since water vapor or oxygen gas is used as the second gas, the metal atoms are efficiently oxidized at low cost, and the second operation can be completed in a short time.

(Clause 3)

In the ion analyzer recited in the above-described clause 1 or 2,

the control unit is configured to generate radicals and/or ions by introducing the second gas into the inside of the insulating tube while supplying radio-frequency power to a coil provided in the discharge unit in a state where the inside of the insulating tube is evacuated during the second operation.

In the ion analyzer of the clause 3, since the radicals and/or ions are generated, the oxidation reaction efficiency and/or the removal efficiency of the metal are higher than those of using the second gas which is a non-radical species as it is, and the second operation can be completed in a short time.

(Clause 4)

In the ion analyzer recited in any one of clauses 1 to 3,

the insulating tube is made of aluminum oxide or silicon dioxide.

In the ion analyzer of the clause 4, since the insulating tube made of aluminum oxide or silicon dioxide which is easily available and is relatively inexpensive is used, the device can be configured simply and inexpensively.

(Clause 5)

Another aspect of the present invention is an ion analyzer configured to generate product ions from precursor ions derived from a sample component, and analyze the product ions, the ion analyzer including:

a reaction chamber into which the precursor ions are introduced;

a gas supply unit capable of supplying a first gas which is a gas having oxidizing ability and a second gas which is a gas having reducing ability;

a radical generation unit configured to generate radicals from the first gas;

a radical introduction unit configured to introduce the radicals generated in the radical generation unit into an inside of the reaction chamber; and

a control unit configured to control operations of the gas supply unit, the radical generation unit, and the radical introduction unit, the control unit being configured to perform a first operation of introducing the radicals generated from the first gas by the radical generation unit into the inside of the reaction chamber and a second operation of introducing the second gas into the inside of the reaction chamber.

In the ion analyzer of the clause 5, under the control of the control unit, the first operation of generating radicals from the first gas and introducing the radicals into the inside of the reaction chamber, and a second operation of generating radicals from the second gas and introducing the radicals into the inside of the reaction chamber by the radical introduction unit are executed. The first operation is a measurement operation performed to generate product ions by reacting precursor ions derived from a sample component with radicals.

The reaction chamber is, for example, a collision cell or an ion trap. A collision cell or an ion trap used in an ion analyzer generally has a metal electrode, and applies a predetermined radio-frequency voltage or direct-current voltage to the electrode to mass-separate, trap, or converge ions. In the ion analyzer of the fifth clause, metal oxide formed on an electrode surface by the irradiation of oxygen radicals or the introduction of the ions derived from the sample component is reduced by the second gas by performing the second operation at the time of non-measurement, so that it is possible to suppress a decrease in the detection sensitivity and the mass accuracy of the product ions when the sample component is analyzed by the first operation.

(Clause 6)

In the ion analyzer recited in the above-described clause 5,

the first gas is oxygen gas, water vapor, or ozone gas.

In the ion analyzer of the clause 6, the metal oxide formed on the electrode surface is reduced in the ion analyzer which generates radicals using oxygen gas, water vapor, or ozone gas as the first gas, and it is possible to suppress a decrease in the detection sensitivity and the mass accuracy of the product ions when the sample component is analyzed by the first operation.

(Clause 7)

In the ion analyzer recited in the above-described clause 5 or 6,

the second gas is any of a hydrogen gas, a nitrogen gas, and a gas of a compound containing a hydrogen atom, a nitrogen atom, or an oxygen atom.

In the ion analyzer of the clause 7, since the hydrogen gas, the nitrogen gas, and the gas of the compound containing a hydrogen atom or a nitrogen atom, which have high reducing ability, are used as the second gas, the efficiency of the reduction reaction of an insulator on the surface of the metal electrode is high, and the second operation can be completed in a short time.

(Clause 8)

In the ion analyzer recited in any one of the above-described clauses 5 to 7,

the control unit is configured to generate radicals or ions from the second gas by the radical generator and introduce the radicals or ions into the inside of the reaction chamber during the second operation.

In the ion analyzer of the clause 8, since the radicals or ions having higher reactivity than gases are introduced into the inside of the reaction chamber, the efficiency of the reduction reaction of the insulator on the surface of the metal electrode is increased, and the second operation can be completed in a short time.

(Clause 9)

The ion analyzer recited in any one of the above-described clauses 5 to 8 further includes:

an electrode provided inside the reaction chamber; and

a heating unit configured to heat the electrode.

In the ion analyzer of the clause 9, since the surface of the electrode is heated, the efficiency of the reduction reaction of the insulator on the surface of the metal electrode is increased, and the second operation can be completed in a short time.

(Clause 10)

Still another aspect of the present invention is an ion analyzer configured to generate product ions from precursor ions derived from a sample component, and analyze the product ions, the ion analyzer including:

a reaction chamber into which the precursor ions are introduced;

an oxidation reactant introduction unit configured to introduce a gas or a radical having oxidizing ability into an inside of the reaction chamber;

an electrode disposed in the reaction chamber and/or in a space communicating with the reaction chamber, the electrode having a surface formed of a metal whose oxide has a thermal decomposition temperature of 500° C. or lower; and

a heating unit configured to heat the electrode to the thermal decomposition temperature.

The ion analyzer recited in the clause 10 generates product ions from precursor ions derived from a sample component by a gas or a radical having oxidizing ability. In this ion analyzer, while analysis of introducing a gas or a radical having oxidizing ability into the reaction chamber to generate precursor ions is repeatedly performed, surfaces of an electrode disposed in the reaction chamber and an electrode disposed in a space (for example, an ion transport optical system or a mass separation unit) communicating with the reaction chamber are oxidized. In the ion analyzer of the third aspect, since the electrode having the surface formed of the metal in which the thermal decomposition temperature of the oxide is 500° C. or lower is used in the reaction chamber and/or the space communicating with the reaction chamber, it is possible to remove the oxide without causing expansion or distortion in the electrode and to suppress a decrease in the detection sensitivity and the mass accuracy of the product ions.

(Clause 11)

The ion analyzer recited in the clause 10 further includes:

a control unit configured to control operations of the oxidation reactant introduction unit and the heating unit, the control unit being configured to perform a first operation of introducing a gas or a radical having oxidizing ability into the inside of the reaction chamber and a second operation of heating the electrode to the thermal decomposition temperature.

Although a heating operation of the electrode in the ion analyzer recited in the clause 10 can be performed by a user himself/herself, by using the ion analyzer recited in the clause 11, maintenance can be performed without bothering the user under the control of the control unit.

(Clause 12)

In the ion analyzer recited in the clause 10 or 11,

the thermal decomposition temperature of the oxide of the metal is 200° C. or lower.

(Clause 13)

In the ion analyzer recited in the clauses 10 to 12,

the metal is gold, platinum, iridium, palladium, or silver.

In the ion analyzer recited in the clause 12, since the metal oxide is removed at 200° C. or lower, even in a device using a resin insulator, the oxide can be removed without causing deformation or damage to the insulator, and deterioration of the detection sensitivity and the mass accuracy of the product ions can be suppressed. Examples of the metal having a thermal decomposition temperature of the oxide of 200° C. or lower include gold, platinum, iridium, palladium, and silver in the ion analyzer of the clause 13.

(Clause 14)

The ion analyzer recited in any one of the clauses 10 to 13 further includes:

a hydrogen introduction unit configured to introduce a hydrogen gas into the inside of the reaction chamber.

In the ion analyzer recited in the clause 14, thermal decomposition of the metal oxide can be promoted by introducing a hydrogen gas having reducibility into the inside of the reaction chamber when the electrode is heated.

(Clause 15)

In the ion analyzer recited in any one of the clauses 10 to 14,

the gas or the radical having oxidizing ability is any of an oxygen gas, an oxygen radical, an hydroxyl radical, an ozone gas, and a carbon monoxide gas.

The ion analyzer recited in the clauses 10 to 14 can be suitably used in an ion analyzer which generates product ions from precursor ions using any of an oxygen gas, an oxygen radical, a hydroxyl radical, an ozone gas, and a carbon monoxide gas, for example, as in the ion analyzer recited in the clause 15.

### REFERENCE SIGNS LIST

1 . . . Ionization Source
2 . . . Ion Trap
21 . . . Ring Electrode
22 . . . Inlet-Side Endcap electrode
23 . . . Ion introduction hole
24 . . . Outlet-Side Endcap electrode
25 . . . Ion ejection hole
26 . . . Radical Particle Introduction Port
27 . . . Radical Particle Releasing Port
3 . . . Time-Of-Flight Mass Separator
4 . . . Ion Detector
5 . . . Radical Generation/Irradiation Unit
51 . . . Radical Generation Chamber
52 . . . First Gas Supply Source
53 . . . Second Gas Supply Source
54 . . . Radio-Frequency Plasma Source
541 . . . Microwave Supply Source
542 . . . Three Stub Tuner
55 . . . Nozzle
551 . . . Tubular Body
552 . . . Spiral Antenna
57 . . . Vacuum Pump
58, 59 . . . Valve
60 . . . Transport Pipe
601 . . . Head Unit
6 . . . Inert Gas supplier
71 . . . Trap Voltage Generator
72 . . . Device Control Unit
73 . . . Heater
8 . . . Chamber
80 . . . Ionization Chamber
801 . . . Ionization Source
81 . . . First Intermediate Vacuum Chamber
811 . . . Ion Guide
82 . . . Second Intermediate Vacuum Chamber
821 . . . Ion Guide (Second Embodiment)
822 . . . Ion Guide (Third Embodiment)
83 . . . Analysis Chamber
831 . . . Front-Stage Quadrupole Mass Filter (Second Embodiment)
832 . . . Collision Cell
833 . . . Ion Guide (Second Embodiment)
833 . . . Multipole Ion Guide
834 . . . Rear-Stage Quadrupole Mass Filter (Second Embodiment)
835 . . . Ion Detector
836 . . . Front-Stage Quadrupole Mass Filter (Third Embodiment)
837 . . . Ion Guide (Third Embodiment)
838 . . . Rear-Stage Quadrupole Mass Filter (Third Embodiment)
9 . . . Control/Processing Unit
91 . . . Storage Unit
92 . . . Operation Mode Selection Unit
93 . . . Operation Control Unit (First Embodiment)
931 . . . First Operation Control Unit (First Embodiment)
932 . . . Second Operation Control Unit (First Embodiment)
94 . . . Operation Mode Selection Unit (Second Embodiment)
95 . . . Operation Control Unit (Second Embodiment)
951 . . . First Operation Control Unit (Second Embodiment)
952 . . . Second Operation Control Unit (Second Embodiment)
96 . . . Operation Mode Selection Unit (Third Embodiment)
97 . . . Operation Control Unit (Third Embodiment)
971 . . . First Operation Control Unit (Third Embodiment)
972 . . . Second Operation Control Unit (Third Embodiment)
98 . . . Input Unit
99 . . . Display Unit
10 . . . Hydrogen Gas Supply Unit
101 . . . Hydrogen Gas Supply Source
102 . . . Valve
103 . . . Gas Introduction Tube
C . . . Ion Optical Axis

1. An ion analyzer configured to generate product ions from precursor ions derived from a sample component, and analyze the product ions, the ion analyzer comprising:
a reaction chamber into which the precursor ions are introduced;
a radical generation unit including an insulating tube, and a discharge unit configured to generate a discharge inside the insulating tube;
a gas supply unit capable of selectively supplying a first gas which is a gas serving as a raw material of radicals, and a second gas which is any of an oxygen gas, an ozone gas, a nitrogen gas, a gas of a compound containing an oxygen atom or a nitrogen atom, and a rare gas to an inside of the insulating tube;
an evacuation unit configured to evacuate the inside of the insulating tube;
a radical introduction unit configured to introduce radicals generated inside the insulating tube into an inside of the reaction chamber; and
a control unit configured to control operations of the radical generation unit, the gas supply unit, the evacuation unit, and the radical introduction unit, the control unit being configured to perform a first operation of introducing the first gas into the inside of the insulating tube in a state where the inside of the insulating tube is evacuated, generating radicals by generating a discharge, and introducing the radicals into the inside of the reaction chamber, and a second operation of introducing the second gas into the inside of the insulating tube.

2. The ion analyzer according to claim 1, wherein the second gas is water vapor or oxygen gas.

3. The ion analyzer according to claim 1, wherein the control unit is configured to generate radicals and/or ions by introducing the second gas into the inside of the insulating tube while supplying radio-frequency power to a coil provided in the discharge unit in a state where the inside of the insulating tube is evacuated during the second operation.

4. The ion analyzer according to claim 1, wherein the insulating tube is made of aluminum oxide or silicon dioxide.

5. An ion analyzer configured to generate product ions from precursor ions derived from a sample component, and analyze the product ions, the ion analyzer comprising:
a reaction chamber into which the precursor ions are introduced;
a gas supply unit capable of supplying a first gas which is a gas having oxidizing ability and a second gas which is a gas having reducing ability;
a radical generation unit configured to generate radicals from the first gas;
a radical introduction unit configured to introduce the radicals generated in the radical generation unit into an inside of the reaction chamber; and
a control unit configured to control operations of the gas supply unit, the radical generation unit, and the radical introduction unit, the control unit being configured to perform a first operation of introducing the radicals generated from the first gas by the radical generation unit into the inside of the reaction chamber and a second operation of introducing the second gas into the inside of the reaction chamber.

6. The ion analyzer according to claim 5, wherein the first gas is oxygen gas, water vapor, or ozone gas.

7. The ion analyzer according to claim 5, wherein the second gas is any of a hydrogen gas, a nitrogen gas, and a gas of a compound containing a hydrogen atom, a nitrogen atom, or an oxygen atom.

8. The ion analyzer according to claim 5, wherein the control unit is configured to generate radicals from the second gas by the radical generation unit and introduce the radicals into the inside of the reaction chamber during the second operation.

9. The ion analyzer according to claim 5, further comprising:
an electrode provided inside the reaction chamber; and
a heating unit configured to heat the electrode.

10. An ion analyzer configured to generate product ions from precursor ions derived from a sample component, and analyze the product ions, the ion analyzer comprising:
a reaction chamber into which the precursor ions are introduced;
an oxidation reactant introduction unit configured to introduce a gas or a radical having oxidizing ability into an inside of the reaction chamber;
an electrode disposed in the reaction chamber and/or in a space communicating with the reaction chamber, the electrode having a surface formed of a metal whose oxide has a thermal decomposition temperature of 500° C. or lower; and
a heating unit configured to heat the electrode to the thermal decomposition temperature.

11. The ion analyzer according to claim 10, further comprising
a control unit configured to control operations of the oxidation reactant introduction unit and the heating unit, the control unit being configured to perform a first operation of introducing a gas or a radical having oxidizing ability into the inside of the reaction chamber and a second operation of heating the electrode to the thermal decomposition temperature.

12. The ion analyzer according to claim 10, wherein the thermal decomposition temperature of the oxide of the metal is 200° C. or lower.

13. The ion analyzer according to claim 10, wherein the metal is gold, platinum, iridium, palladium, or silver.

14. The ion analyzer according to claim 10, further comprising
a hydrogen introduction unit configured to introduce a hydrogen gas into the inside of the reaction chamber.

15. The ion analyzer according to claim 10, wherein the gas or the radical having oxidizing ability is any of an oxygen gas, an oxygen radical, an hydroxyl radical, an ozone gas, and a carbon monoxide gas.
